(19) United States
(12) Patent Application Publication
(10) Pub. No.: US 2006/0125687 A1
(43) Pub. Date: Jun. 15, 2006

(54) Distributed exciter in phased array

(75) Inventor: John S. Greeley, Ambler, PA (US)

Correspondence Address: MAINE & ASMUS, P. O. BOX 3445, NASHUA, NH, 03061, US

(73) Assignees: BAE SYSTEMS INFORMATION, Nashua, NH (US); ELECTRONIC SYSTEMS INTEGRATION INC., Nashua, NH (US)

(21) Appl. No.: 11/008,504

(22) Filed: Dec. 9, 2004

(51) Int. Cl. H01Q 3/26; H04B 7/10

(52) U.S. Cl. 342/368; 342/361

(57) ABSTRACT

A wideband multi-signal distributed exciter system for use with a phased antenna array is disclosed. The system includes a multi-signal generator that is configured with a dual direct digital frequency synthesizer (DDS) core, and is capable of generating multi-polarization signals over a given frequency range (e.g., 50 to 500 MHz) for each of N signals associated with a corresponding antenna element. An RF converter is adapted to receive multi-polarization signals from the multi-signal generator, and to convert those signals to a transmission frequency (e.g., 100 MHz to 10 GHz). A 2N signal summing module can be used to receive multi-polarization signals from each of the N dual DDS functions, and to generate an overall multi-polarization output signal that is provided for RF conversion. An identical set of multi-signal generator and RF converter modules can be associated with each element, thereby providing a high degree of modularity and interchangeability.

### FIELD OF THE INVENTION

The invention relates to antennas, and more particularly, to phased array techniques and architectures that enable modularity and enhanced performance, including the ability to independently steer individual beams for each signal.

### BACKGROUND OF THE INVENTION

A phased array is a group of antennas in which the relative phases of respective signals feeding the antennas are varied so that radiation patterns of the array are coordinated so that the radio wave signals are reinforced in certain directions and suppressed in others. The relative amplitudes of the signals, as well as the constructive and destructive interference effects among the signals radiated by the individual antennas, determine the effective radiation pattern of the array.

A phased array may be used to point a fixed radiation pattern, or to scan rapidly in azimuth or elevation. Transmitters utilizing phased array techniques have been implemented successfully for many years. Common applications for phased arrays include, for example, narrow band military radar systems.

More recently, the capability of phased array techniques has gradually extended to include wide band, multi-signal, multi-polarization single beam military jammers. However, the feed network and support electronics for this type of jammer is complex and contains a large number of individual hardware RF elements including multiple amplitude adjust modules (coarse and fine), time delay modules, phase shift modules, and directional couplers.

Most recently, an additional requirement of phased arrays includes the ability to independently steer individual beams for each signal. Adding this capability further increases the system complexity by nearly the number of signal beams. As such, the system implementation with conventional phased array architectures approaches a practical limit that precludes extending the architecture to more than a hand full of radio wave signals.

This is because conventional phased array architectures separate signal generation, beam forming and signal polarization functions along the RF distribution path. This leads to a design that places many demands on the RF elements of the system when beam steering and signal polarization control is required. One such RF element for example, the true time delay (TTD) phase shifter, has been popular in wide bandwidth phased arrays. This type of phase shifter has the ability to facilitate wide bandwidth beam steering without producing a beam degradation known as squint.

Unfortunately, for large phased arrays with large steering angles, the TTD phase shifter nears the limit of its own technology and must be controlled and calibrated with an internal microprocessor and factory calibration table. One of these phase shifters is needed for each array element. To maintain intended beam steering performance, phase matching is required for the remainder of the RF path to each phased array element. Since TTD phase shifters are strictly low power level elements, the RF path must include all of the low and high power RF amplifiers, filters and couplers. Each RF path, including all of the interconnecting cables must be calibrated and phase matched to each other. In the case of the most recent jammer requirements, independently steerable beams are desired for each of multiple signals. This means that each of these signals would require its own TTD for each signal beam. The additional requirement of polarization control and amplitude leveling adds even further to the system complexity in the area of RF hardware. In short, conventional phased array techniques and beam forming architectures are relatively large, require more components, use a significant amount of power, and provide limited flexibility.

What is needed, therefore, are phased array techniques and architectures that provide modularity and enhanced performance relative to conventional techniques and architectures.

### BRIEF SUMMARY OF THE INVENTION

One embodiment of the present invention provides a wideband multi-signal distributed exciter system for use with a phased antenna array. The system includes a multi-signal generator that is configured with a dual direct digital frequency synthesizer (DDS) core, and is capable of generating multi-polarization signals over a given frequency range for each of N signals associated with a corresponding antenna element. An RF converter is adapted to receive multi-polarization signals from the multi-signal generator, and to convert those signals to a transmission frequency. The multi-signal generator may include a dual DDS function (e.g., DDS chip or FPGA configured to carry out DDS functions) for each of the N signals. In this multi-signal case, the system may further include a 2N signal summing module that is adapted to receive multi-polarization signals from each of the N dual DDS functions, and to generate an overall multi-polarization output signal. The overall multi-polarization output signal can represent, for example, a sum of N vertical signals and a sum of N horizontal signals. Other polarization schemes are possible here as well.

The multi-polarization signals generated by the multi-signal generator can be based, for instance, on amplitude, frequency, and phase information provided to the multi-signal generator by a frequency selective phase and amplitude detector. Note that this detector can be conventional or custom. Functions performed by the multi-signal generator may include, for example, signal generation, modulation, phase and amplitude control, and signal summing functions. The RF converter can be adapted to receive multi-polarization signals from the multi-signal generator, and to convert those signals to a wideband of transmission frequencies ranging, for example, from about 100 MHz to 10 GHz. In one particular case, the given frequency range of multi-polarization signals generated by the multi-signal generator is about 160 MHz to 300 MHz, and the transmission frequency associated with the RF converter is in the range of 100 MHz to 7000 MHz. The RF converter may be configured, for instance, with a switched filter bank that covers the wideband of transmission frequencies. In one such particular case, the RF converter includes a first stage configured as a frequency up-converter, and a second frequency converter stage configured with a filter bank of preselectors that covers a wideband of transmission frequencies ranging from about 100 MHz to 7 GHz.

The system may further include an amplifier that is adapted to amplify the signals converted to transmission frequencies prior to transmission. Note that the phased antenna array can include multiple antenna elements. In one such particular case, there is an identical multi-signal generator and RF converter set associated with each element. Each identical set may also include an amplifier. Likewise, there can be an identical multi-signal generator, RF converter, and amplifier set associated with each of the antenna array bands. Thus, a high degree of modularity and interchangeability is provided.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of an antenna array configured with a distributed exciter in accordance with one embodiment of the present invention.

FIG. 2 is a block diagram of a multi-signal generator, including signal source module functions, configured in accordance with one embodiment of the present invention.

FIG. 3 is a block diagram of a multi-signal distributed exciter RF up-converter configured in accordance with one embodiment of the present invention.

### DETAILED DESCRIPTION OF THE INVENTION

Rather than extend conventional phased array beam steering and polarization technology to meet additional performance demands, an embodiment of the present invention is configured to simplify the RF hardware to the maximum degree possible by moving all of the beam steering, delay compensation (TTD-related), phase matching, amplitude leveling and polarization control functions to a highly modular distributed exciter with coordinated and precise phase and amplitude control.

Here, the phase characteristics of the array, its amplifiers and the RF distributing hardware can be characterized (as opposed to matched) for each element RF path and the results reduced to a digital phase compensation table with modulo 360 degree output (e.g., included in a direct digital frequency synthesizer chip). Likewise the requirements for beam steering verse frequency for each array element can also be pre-calculated to result in a phase offset for steering. Signal polarization control is accomplished through a combination of amplitude and channel-to-channel phase control as will be explained herein.

By integrating RF distribution and signal combining functionality, many RF components such as switches, attenuators, phase shifters, splitters, combiners, time delays, and phase matched cabling are eliminated. Phased arrays configured in accordance with the principles of the present invention provide improved modularity, greater flexibility in beam-forming and multi-signal bandwidth, enhanced amplifier reliability higher average (ERP), and the ability for selectivity of allocated signals.

Antenna Array

Unlike conventional architectures, which separate the functions of signal generation, beam forming, and signal polarization, one embodiment of the present invention combines these functions into a single circuit chip or chip set that is associated with each array element. The circuit is configured to generate multiple baseband signals for conversion to the desired output frequency. In addition, the functions of signal generation and modulation are combined with those currently performed by the true time delay (TTD) beam steering phase shifters, signal polarization complex weights, and amplitude control.

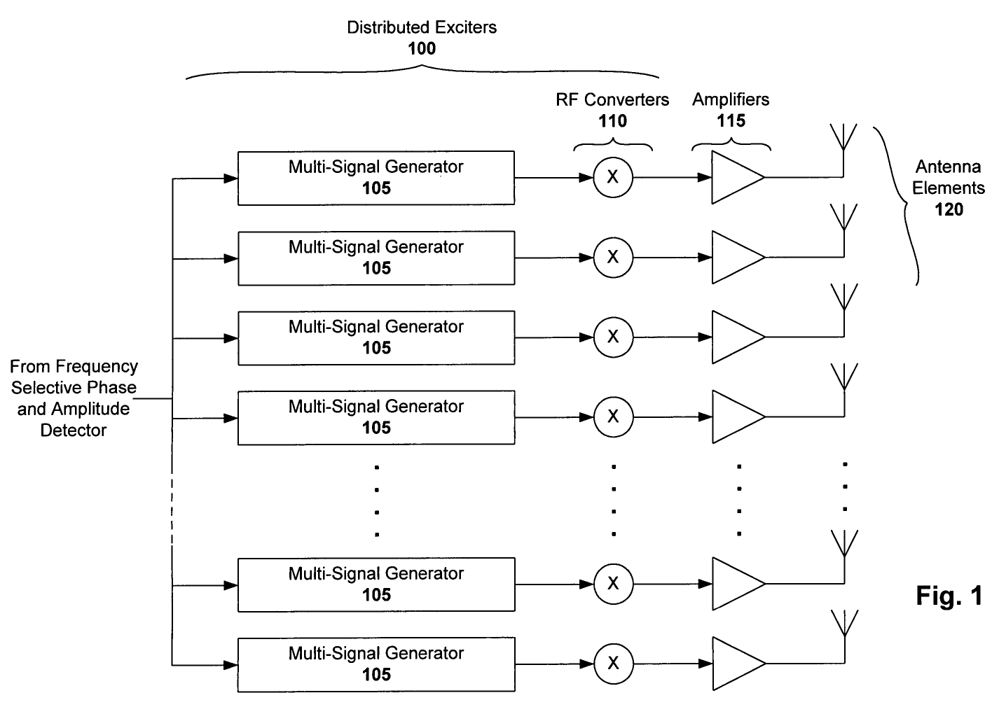

FIG. 1 is a block diagram of an antenna array configured with a distributed exciter in accordance with one embodiment of the present invention. As can be seen, the array includes a number of antenna elements 120. Each of the elements 120 is operatively coupled to a baseband distributed exciter module 100 via a corresponding amplifier 115. Each distributed exciter module 100 includes a multi-signal generator 105 and an RF converter 110. Amplitude, frequency, and phase information is provided to the multi-signal generator 105 by a conventional or custom frequency selective phase and amplitude detector.

In one example configuration, each multi-signal generator 105 is implemented as a multi-signal DDS based signal synthesizer that includes signal generation, modulation, phase and amplitude control, as well as signal summing functions. Each multi-signal generator 105 is the same to provide a highly modular configuration, and is capable of generating precise phase controlled signals over a given frequency range (e.g., 160 to 300 MHz), depending on the clock speed of the DDS.

The output of each multi-signal generator 105 is a wide band multi-polarization signal (e.g., vertical and horizontal signals), which is then provided to a corresponding RF converter 1 10. Each RF converter 1 10 receives the wide band signal from the corresponding multi-signal generator 105, and up-converts that signal for transmission. Each RF converter 110 is identical and interchangeable in all bands to further provide a high degree of modularity.

In one particular case, the RF converters 110 are each configured as a dual stage up-converter that utilizes phase locked loop synthesized local oscillators that are synchronized to a master clock. The output of the DDS functions of the multi-signal generators 105 are up-converted to a final desired output frequency (e.g., between 100 MHz and 6.7 GHz). A high-speed switched filter bank covering the desired output range would be used to ensure the purity and agility of the up-converted signal. Note that the DDS, RF conversion and filtering functions of this particular embodiment comprise a modular distributed exciter 100.

The up-converted output signal of each RF converter 110 is then provided to the corresponding amplifier 115 for conventional amplification so that the signal can be transmitted by the corresponding antenna element 120.

In one example application, the bandwidth of each distributed exciter module 100 ranges from about 100 MHz to 6.7 GHz. The wide operating frequency range and the ability to independently control all necessary attributes of the distributed exciter module 100 configuration enables commonality and reuse for each antenna element 120 in the array. For physical reasons, even wide bandwidth phased arrays are typically limited to no more than a 3:1 frequency range. An example configuration of a distributed exciter module 100 that covers 100 MHz to 6.7 GHz enables the module 100 to be used interchangeably across four of more different jamming arrays, each covering a different frequency range.

Note, however, that other bandwidth ranges are possible here, as will be apparent in light of this disclosure. The present invention is not intended to be limited to any one configuration or bandwidth range.

Multi-Signal Generator

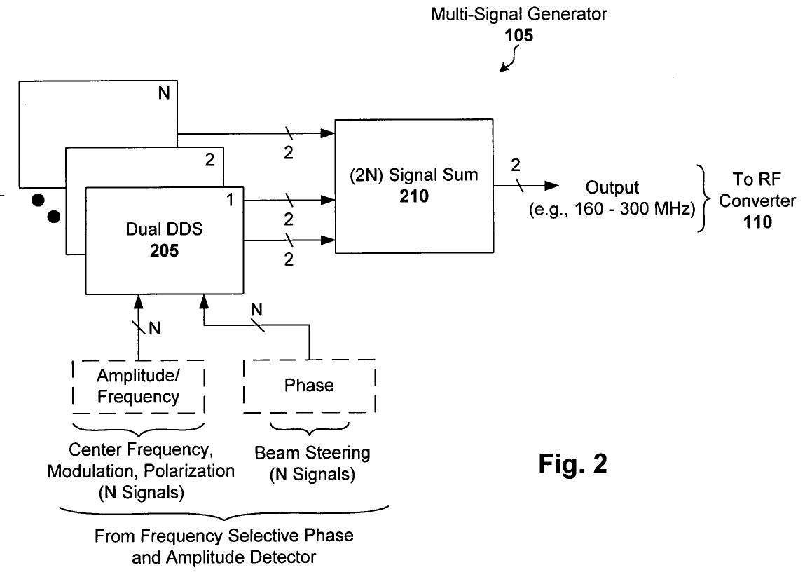

FIG. 2 is a block diagram of a multi-signal generator 105, including signal source module functions, configured in accordance with one embodiment of the present invention. As can be seen, the multi-signal generator 105 is built around a wide bandwidth direct digital frequency synthesizer (DDS) core.

In particular, the multi-signal generator 105 of this example is configured as a baseband multi-signal generator that includes a dual DDS module 205 for each of the N signals associated with a corresponding antenna element. Each DDS module 205 generates two outputs to provide a multi-polarization signal (e.g., vertical and horizontal signals).

In the case of multiple simultaneous signals, the output multiple DDS functions (1 through N) are summed using a 2 N signal summing module 210, which can be implemented with conventional summing techniques. In any case, each of the 2 N output signals generated by the N DDS modules 205 are summed. The 2 N signal summing module 210 then generates the overall multi-polarization output signal (e.g., sum of all N vertical signals and sum of all N horizontal signals). This signal is representative of a 2N wide band multi-polarization signal.

The DDS modules 205 can be implemented with conventional technology, and provide signal generation, modulation, phase and amplitude control, as well as signal summing functions. For example, each of the N DDS modules 205 can be implemented with a AD9858 DDS chip, or other commercially available DDS chip solutions. Alternatively, each of the N DDS modules 205 can be implemented using a field programmable gate array (FPGA) or other suitable programmable environment, or a combination of a DDS chip and one or more FPGAs.

In the AD9858 DDS case, a 1 GHz clock is used to develop signals in the range of 160 to 300 MHz. Signals generated by the DDS can be both phase and amplitude controlled at a very high rate (e.g., greater than 50 MHz). This phase and amplitude control is used to both modulate the signal and control the relative phase between signals developed by other multi-signal generators 105.

N signals of amplitude/frequency and phase information are provided to the DDS modules 205 from a frequency selective phase and amplitude detector, which can be implemented with conventional technology.

Alternatively, the frequency selective phase and amplitude detector can be implemented as described in U.S. patent application Ser. No. 10/949,046, filed Sep. 24, 2004, titled, “Frequency Selective Leveling Loop for Multi-Signal Phased Array Transmitters”, which is herein incorporated by reference in its entirety. In such a configuration, a sample of a composite exciter signal is provided to the input of the phase and amplitude sensor (detector). The sensor converts the sample signal to its real and imaginary components for both I and Q channels using a 90° hybrid and mixers. Samples of each individual exciter signal to be measured are available for use as a down conversion local oscillator. In particular, each of the I and Q channels are mixed with amplitude limited versions of the Fₘᵢₙ to Fₘₐₓ exciter signals, which are sequentially switched into the mixer, one signal at a time. Frequency selectivity is obtained by low pass filtering the non-synchronous portion of the detected output. The RF gain control can be calibrated to obtain an absolute power reading, and the low pass filters are set below minimum signal spacing. The I and Q outputs of the low pass filters are then provided back to the multi-signal exciter, thereby providing a leveling loop for phase and/or amplitude error correction of the exciter signals.

In any case, N signals amplitude/frequency and phase information are provided to the N DDS modules 205, thereby enabling signal generation, modulation, beam steering, and polarization functionality to be carried out by the N DDS modules 205.

RF Converter

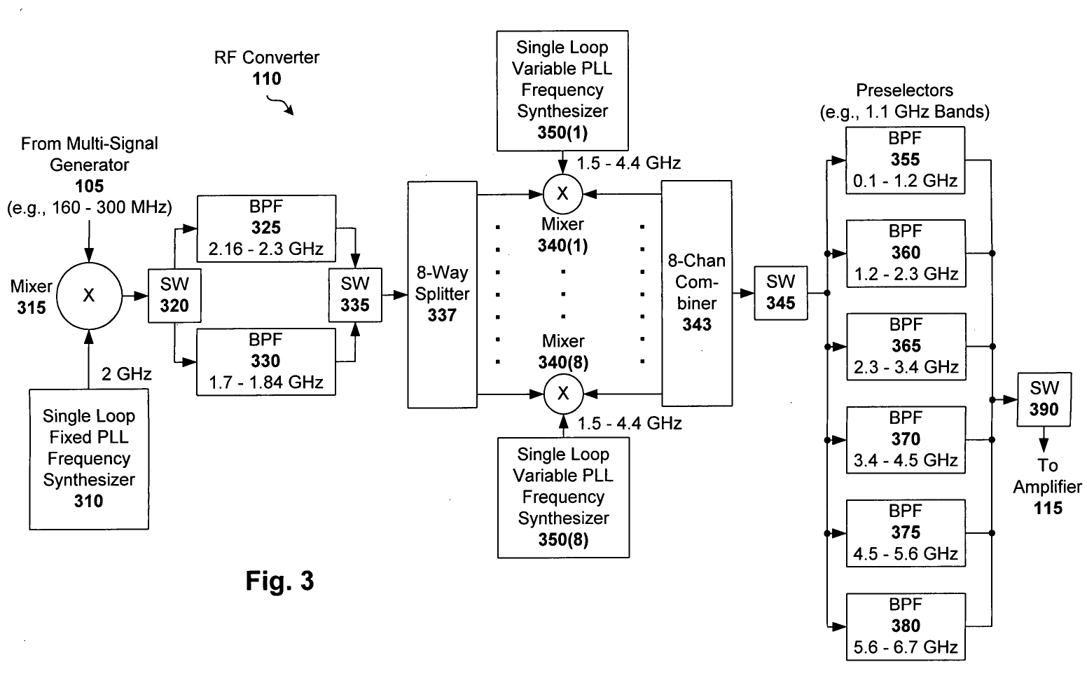

FIG. 3 is a block diagram of a multi-signal distributed exciter RF converter 110 configured in accordance with one embodiment of the present invention. Each RF converter 110 receives the 2 N wide band multi-polarization signal from the corresponding distributed exciter module 105, and up-converts that signal for transmission. Each RF converter 110 can be configured to be identical and interchangeable in all bands to further provide a high degree of modularity. In the example configuration shown, the RF converter 110 is configured with two stages.

In more detail, the multi-polarization signal received from the multi-signal generator 105 is in the frequency range of about 160 MHz to 300 MHz, and is input to the first stage of the RF converter 110. This first stage is configured as a 140 MHz bandwidth up-converter. In particular, mixer 315 is used to up-convert the input signal to the 2 GHz range, using a single loop fixed phase locked loop (PLL) frequency synthesizer 310. Switch (SW) 320 then switches the output of the mixer 315 through each of the bandpass filters (BPF) 325 and 330. In this example, BPF 325 is configured to pass the upper target band (2.16 GHz to 2.3 GHz), and BPF 330 is configured to pass the lower target band (1.7 GHz to 1.84 GHz).

Switch 335 switches the respective outputs of the BPF 325 and BPF 330 to the second stage. The second stage is a multi-channel converter consisting of an 8-way signal splitter 337, eight independent mixers 340, eight independent single loop variable PLL frequency synthesizers 350, and an 8-channel signal combiner 343. Mixers 340 of the second stage receive the output of the first stage and further convert that output using the single loop variable PLL frequency synthesizers 350, which are each configured to provide an oscillator signal in the range of about 1.5 GHz to 4.0 GHz. The multi-channel second stage converter allows the input bandwidth of the 140 MHz bandwidth up-converter to be expanded to cover the instantaneous bandwidth of each of the output preselectors 355 through 380.

Switch 345 switches the output of 8-channel signal combiner 343 to a bank of six 1.1 GHz band preselectors. In particular, BPF 355 is configured with a pass band of about 100 MHz to about 1.2 GHz, BPF 360 is configured with a pass band of about 1.2 GHz to about 2.3 GHz, BPF 365 is configured with a pass band of about 2.3 GHz to about 3.4 GHz, BPF 370 is configured with a pass band of about 3.4 GHz to about 4.5 GHz, BPF 375 is configured with a pass band of about 4.5 GHz to about 5.6 GHz, and BPF 380 is configured with a pass band of 5.6 GHz to about 6.7 GHz. This high-speed switched filter bank of preselectors covers the desired output frequency range (which in this example embodiment is 100 MHz to 6.7 GHz), and is used to ensure the purity and agility of the up-converted signal. Note that additional higher frequency pass bands (e.g., 6.7 GHz to 7.8 GHz and 7.8 GHz to 8.9 GHz) could be provided by increasing the local oscillator frequency of synthesizers 350 (e.g., from 4.4 GHz to 6.6 GHz), and providing the additional preselector BPFs.

Switch 390 is used to switch each of the filter outputs to the amplifier 115, in preparation for transmission via the corresponding antenna element 120. Note that the local oscillators provided by frequency synthesizers 310 and 350 are synchronized to a master clock (not shown) to facilitate operation of the two-stage up-converter configuration. Also, switches 320, 335, 345, and 390 can operate under the control of a local processor, also synchronized to a master clock. Each of the modules making up the RF converter 110 can be implemented with conventional technology and techniques. The RF converter 110 can be implemented, for example, on a microwave printed wiring board (PCB) with all filters (e.g., BPFs 325, 330, and 355-380) embedded in the PCB. Other RF converter configurations and filtering schemes will be apparent in light of this disclosure, and the present invention is not intended to be limited to any one such embodiment or configuration.

Thus, a distributed exciter configured in accordance with the principles of the present invention addresses issues associated with multi-signal aspects of high power phased arrays. The capabilities, features and benefits of the distributed exciter architecture include: a reduction in RF distribution and signal combining between the exciter and beam forming array; elimination of many RF components including switches, attenuators, phase shifters, true time delay, splitters, combiners and phase matched cables; improved modularity by associating each array element with its own signal processing; total flexibility in beam forming and multi-signal bandwidth through better phase, amplitude and time delay resolution and range; better amplifier reliability and potentially higher average ERP through digital control of peak RF drive levels; the ability to selectively allocate signals within the array for optimum performance; and the ability to control signal polarization through amplitude and phase of each dual channel signal source.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A wideband multi-signal distributed exciter system for use with a phased antenna array, comprising:
a multi-signal generator configured with a dual direct digital frequency synthesizer (DDS) core, and capable of generating multi-polarization signals over a given frequency range for each of N signals associated with a corresponding antenna element; and
an RF converter adapted to receive multi-polarization signals from the multi-signal generator, and to convert those signals to a transmission frequency.

2. The system of claim 1 wherein the multi-signal generator includes a dual DDS function for each of the N signals, the system further comprising:
a 2 N signal summing module adapted to receive multi-polarization signals from each of the N dual DDS functions, and to generate an overall multi-polarization output signal.

3. The system of claim 2 wherein the overall multi-polarization output signal represents a sum of N vertical signals and a sum of N horizontal signals.

4. The system of claim 1 wherein the multi-polarization signals generated by the multi-signal generator are based on amplitude, frequency, and phase information provided to the multi-signal generator by a frequency selective phase and amplitude detector.

5. The system of claim 1 wherein functions performed by the multi-signal generator include signal generation, modulation, phase and amplitude control, and signal summing functions.

6. The system of claim 1 wherein the phased antenna array includes multiple antenna elements, and there is an identical multi-signal generator and RF converter set associated with each element.

7. The system of claim 1 wherein the given frequency range of multi-polarization signals generated by the multi-signal generator is about 160 MHz to 300 MHz, and the transmission frequency is in the range of 100 MHz to 7000 MHz.

8. The system of claim 1 wherein the RF converter includes a first stage configured as a frequency up-converter, and a second frequency converter stage configured with a filter bank of preselectors that covers a wideband of transmission frequencies ranging from about 100 MHz to 7 GHz.

9. The system of claim 1 wherein the RF converter is configured with a switched filter bank that covers a wideband of transmission frequencies ranging from about 100 MHz to 10 GHz.

10. The system of claim 1 further comprising:
an amplifier adapted to amplify the signals converted to transmission frequencies prior to transmission.

11. A wideband multi-signal distributed exciter system for use with a phased antenna array including multiple antenna elements, comprising:
a multi-signal generator configured with a dual direct digital frequency synthesizer (DDS) core, and capable of generating multi-polarization signals over a given frequency range for each of N signals associated with a corresponding antenna element;
an RF converter adapted to receive multi-polarization signals from the multi-signal generator, and to convert those signals to a transmission frequency; and
an amplifier adapted to amplify converted signals output by the RF converter prior to transmission;
wherein there is an identical multi-signal generator, RF converter, and amplifier set associated with each antenna element.

12. The system of claim 11 wherein the multi-signal generator includes a dual DDS function for each of the N signals, the system further comprising:
a 2 N signal summing module adapted to receive multi-polarization signals from each of the N dual DDS functions, and to generate an overall multi-polarization output signal.

13. The system of claim 11 wherein the multi-polarization signals generated by the multi-signal generator are based on amplitude, frequency, and phase information provided to the multi-signal generator by a frequency selective phase and amplitude detector.

14. The system of claim 11 wherein functions performed by the multi-signal generator include signal generation, modulation, phase and amplitude control, and signal summing functions.

15. The system of claim 11 wherein the RF converter includes a first stage configured as a frequency up-converter, and a second frequency converter stage configured with a filter bank of preselectors that covers a wideband of transmission frequencies ranging from about 100 MHz to 7 GHz.

16. The system of claim 11 wherein the RF converter is configured with a switched filter bank that covers a wideband of transmission frequencies ranging from about 100 MHz to 10 GHz.

17. An antenna array system comprising:
multiple antenna elements;
a multi-signal generator configured with a dual direct digital frequency synthesizer (DDS) core, and capable of generating multi-polarization signals over a given frequency range for each of N signals associated with a corresponding one of the antenna elements;
an RF converter adapted to receive multi-polarization signals from the multi-signal generator, and to convert those signals to a wideband of transmission frequencies ranging from about 100 MHz to 10 GHz; and
an amplifier adapted to amplify converted signals output by the RF converter prior to transmission;
wherein there is an identical multi-signal generator, RF converter, and amplifier set associated with each of the antenna elements.

18. The system of claim 17 wherein the multi-signal generator includes a dual DDS function for each of the N signals, the system further comprising:
a 2 N signal summing module adapted to receive multi-polarization signals from each of the N dual DDS functions, and to generate an overall multi-polarization output signal.

19. The system of claim 17 wherein the multi-polarization signals generated by the multi-signal generator are based on amplitude, frequency, and phase information provided to the multi-signal generator by a frequency selective phase and amplitude detector.

20. The system of claim 17 wherein functions performed by the multi-signal generator include signal generation, modulation, phase and amplitude control, and signal summing functions.
